(19) United States
(12) Patent Application Publication
(10) Pub. No.: US 2018/0112303 A1
(43) Pub. Date: Apr. 26, 2018

(54) METHOD FOR COATING ARTICLE AND FEEDSTOCK FOR THERMAL SPRAY PROCESS

(71) Applicant: GENERAL ELECTRIC TECHNOLOGY GmbH, Baden (CH)

(72) Inventors: Leo Vinod Marcus ANTONY, Chattanooga, TN (US); Kurt William JOHNSON, Soddy Daisy, TN (US); Randall Lee PRICE, Chattanooga, TN (US); Matthew Eric JENNINGS, Chattanooga, TN (US)

(21) Appl. No.: 15/331,221

(22) Filed: Oct. 21, 2016

(51) Int. Cl. C23C 4/11; C23C 4/134; C23C 4/02; C09D 1/00; C09D 7/12; F28F 9/16

(52) U.S. Cl. CPC C23C 4/11; C23C 4/134; C23C 4/02; F28F 9/16; C09D 7/1275; C09D 7/1283; C09D 1/00

(57) ABSTRACT

A feedstock for a thermal spray process is disclosed. The feedstock includes fly ash derived from coal combustion. A method for coating an article is disclosed. The method includes applying the feedstock as a coating precursor by a thermal spray process. The fly ash preferentially forms a coating disposed on a substrate of the article.

### FIELD OF THE INVENTION

The present invention is directed to methods for coating articles and feedstocks for thermal spray processes. More particularly, the present invention is directed to methods for coating articles and feedstocks for thermal spray processes including fly ash in the feedstock.

### BACKGROUND OF THE INVENTION

Coal-fired power plants produce large volumes of fly ash throughout the world. Fly ash is the portion of ash formed while burning coal which is suspended in the flue gas exiting a coal combustion chamber, the major constituents of which are typically silica, alumina, iron oxide, and calcium oxide. While once considered to be mere refuse, fly ash has been utilized in a variety of applications, both for the purpose of reducing waste and also to make economically viable use of the combustion byproducts from burning coal. While upwards of 40% of fly ash is now recycled in the United States for beneficial use, this still leaves almost 60% of the fly ash produced in the United States as an available resource rich in useful elements and mineral compositions.

The boiler components of a coal-fired power plant, are subjected to harsh conditions, including chemical environments, elevated temperatures, and kinetic impacts which can cause erosion and corrosion, even for otherwise durable materials. In particular, the surface of such boiler components may become coated with slag deposits. Although coating systems to reduce erosion and corrosion of boiler components are known, such coating systems are typically expensive, and may form or liberate hexavalent chromium compounds.

### BRIEF DESCRIPTION OF THE INVENTION

In an exemplary embodiment, a method for coating an article includes applying a feedstock as a coating precursor by a thermal spray process. The feedstock includes fly ash. The fly ash preferentially forms a coating disposed on a substrate of the article.

In another exemplary embodiment, a feedstock for a thermal spray process includes fly ash derived from coal combustion.

Other features and advantages of the present invention will be apparent from the following more detailed description of the preferred embodiment, taken in conjunction with the accompanying drawings, which illustrate, by way of example, the principles of the invention.

### BRIEF DESCRIPTION OF THE DRAWINGS

FIG. 1 is a perspective view of a coated article, according to an embodiment of the present disclosure.

FIG. 2 is a cross-sectional view of the coated article of claim 1 taken along lines 2-2, according to an embodiment of the present disclosure.

FIG. 3 is a micrograph depicting showing the cross-section view of FIG. 2, wherein the fly ash is derived from Western coal, according to an embodiment of the present disclosure.

FIG. 4 is a micrograph depicting showing the cross-section view of FIG. 2, wherein the fly ash is derived from Powder River Basin coal, according to an embodiment of the present disclosure.

FIG. 5 is a micrograph depicting showing the cross-section view of FIG. 2, wherein the fly ash is derived from Illinois Basin coal, according to an embodiment of the present disclosure.

Wherever possible, the same reference numbers will be used throughout the drawings to represent the same parts.

### DETAILED DESCRIPTION OF THE INVENTION

Provided are methods for coating articles and feedstocks for thermal spray processes. Embodiments of the present disclosure, reduce or eliminate hexavalent chromium, reduce waste, reduce erosion, reduce corrosion, lower feedstock cost, or a combination thereof.

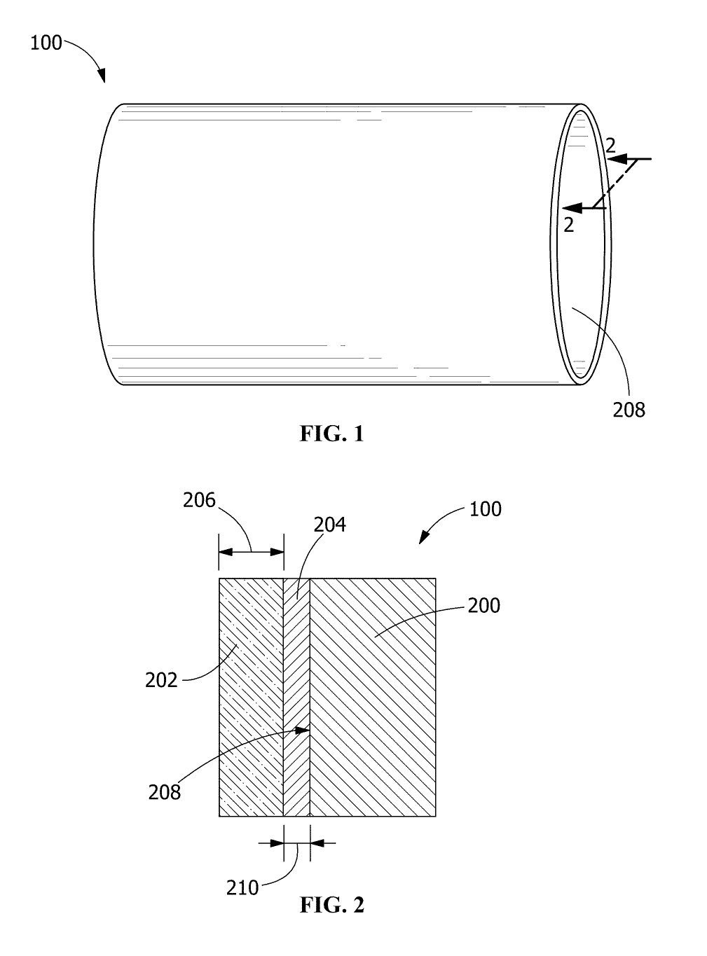

Referring to FIGS. 1 and 2, in one embodiment, a method for coating an article 100 includes applying a feedstock as a coating precursor to a substrate 200 of the article 100. The feedstock includes fly ash, and is applied to the substrate 200 by a thermal spray process. The fly ash in the coating precursor preferentially forms a coating 202 disposed on the substrate 200 of the article 100.

The fly ash may be derived by any suitable method, including, but not limited to, the combustion of coal. Further, the coal combusted may be any suitable coal, originating in the United States of America or internationally, including, but not limited to, Western coal, Powder River Basin coal, Illinois Basin coal, or combinations thereof.

The fly ash may include any suitable chemical composition. The fly ash may include between about 15 wt. % to about 60 wt. % SiO₂, alternatively between about 20 wt. % to about 60 wt. % SiO₂, alternatively between about 30 wt. % to about 60 wt. % SiO₂, alternatively between about 40 wt. % to about 60 wt. % SiO₂, alternatively between about 15 wt. % to about 35 wt. % SiO₂, alternatively between about 25 wt. % to about 45 wt. % SiO₂. The fly ash may include between about 5 wt. % to about 35 wt. % Al₂O₃, alternatively between about 5 wt. % to about 15 wt. % Al₂O₃, alternatively between about 10 wt. % to about 20 wt. % Al₂O₃, alternatively between about 15 wt. % to about 25 wt. % Al₂O₃, alternatively between about 20 wt. % to about 30 wt. % Al₂O₃, alternatively between about 25 wt. % to about 35 wt. % Al₂O₃. The fly ash may include between about 4 wt. % to about 40 wt. % Fe₂O₃, alternatively between about 4 wt. % to about 20 wt. % Fe₂O₃, alternatively between about 10 wt. % to about 25 wt. % Fe₂O₃, alternatively between about 15 to about 30 wt. % Fe₂O₃, alternatively between about 20 wt. % to about 35 wt. % Fe₂O₃, alternatively between about 25 wt. % to about 40 wt. % Fe₂O₃. The fly ash may include between about 1 wt. % to about 40 wt. % CaO, alternatively between about 1 wt. % to about 15 wt. % CaO, alternatively between about 10 wt. % to about 25 wt. % CaO, alternatively between about 20 wt. % to about 35 wt. % CaO, alternatively between about 25 wt. % to about 40 wt. % CaO. The fly ash may include between about 0.1 wt. % to about 15 wt. % MgO. The fly ash may include between about 0.1 wt. % to about 15 wt. % Na₂O. The fly ash may include between about 0.5 wt. % to about 10 wt. % K₂O. The fly ash may include between about 0.5 wt. % to about 10 wt. % TiO₂.

The fly ash may include any suitable particle size distribution, including, but not limited to, a particle distribution between about 200 nm to about 200 μm, alternatively between about 200 nm to about 100 μm, alternatively between about 500 nm to about 500 μm, alternatively between about 1 μm to about 1 mm, alternatively between about 500 μm to about 100 mm.

In one embodiment, the coating precursor further includes up to about 35 wt. % additional material, alternatively up to about 25 wt. % additional material, alternatively up to about 15 wt. % additional material, alternatively between about 5 wt. % to about 35 wt. % additional material, alternatively between about 5 wt. % to about 15 wt. % additional material, alternatively between about 10 wt. % to about 20 wt. % additional material, alternatively between about 15 wt. % to about 25 wt. % additional material, alternatively between about 20 wt. % to about 30 wt. % additional material, alternatively between about 25 wt. % to about 35 wt. % additional material. The additional materials may include any suitable materials, including, but not limited to, MgO, SO₃, Na₂O, K₂O, TiO₂, unburnt carbon, or combinations thereof.

The coating precursor may include a balancing composition. The balancing composition may be any suitable composition, including, but not limited to SiO₂, Al₂O₃, Fe₂O₃, CaO, MgO, SO₃, Na₂O, K₂O, TiO₂, unburnt carbon, or combinations thereof

The thermal spray process may be any suitable spray process in which the coating precursor, including one or more feedstocks, is heated and then selectively deposited or sprayed on a surface to apply a coating on the surface. In one embodiment the thermal spray process includes plasma spraying, air plasma spraying, high-velocity air-fuel spraying (HVAF), high-velocity air plasma spraying (HV-AP), detonation spraying, flame spraying, high velocity oxy-fuel spraying (HVOF), cold (warm) spraying, or combinations thereof.

In one embodiment, wherein the thermal spray process includes air plasma spraying, applying the fly ash includes a fly ash flow rate of between about 1 g/min and about 100 g/min, and an energy input of between 30 kW and about 60 kW, alternatively about 30 kW to about 40 kW, alternatively about 35 kW to about 45 kW, alternatively about 40 kW to about 50 kW, alternatively about 45 kW to about 55 kW, alternatively about 50 kW to about 60 kW, alternatively about 35 kW, alternatively about 45 kW, alternatively about 55 kW. The processing gas may include any suitable gas, including, but not limited to, argon, hydrogen, and combinations thereof In one embodiment, argon is the primary component of the processing gas, and hydrogen is the secondary component of the processing gas.

The coating 202 may include any suitable coating thickness 206, including, but not limited to, a coating thickness 206 between about 25 μm and about 1,000 μm, alternatively between 50 μm and about 500 μm, alternatively between about 100 μm and about 400 μm, alternatively between about 100 μm and about 200 μm, alternatively between about 150 μm and about 250 μm, alternatively between about 200 μm and about 300 μm, alternatively between about 250 μm and about 350 μm, alternatively between about 300 μm and about 400 μm.

In one embodiment, the coating 202 is essentially free of hexavalent chromium. As used herein, “essentially free” may indicate that hexavalent chromium, if present, is only a trace element, alternatively is present in a concentration of less than about 100 ppm, alternatively less than about 10 ppm, alternatively less than about 1 ppm, alternatively less than about 100 ppb, alternatively less than about 10 ppb, alternatively less than about 1 ppb, alternatively less than about 100 ppt, alternatively less than about 10 ppt. In a further embodiment, the coating 202 is free of hexavalent chromium.

The coating 202 may include any suitable porosity, including, but not limited to a porosity of less than about 5%, alternatively less than about 3%, alternatively less than about 2%, alternatively less than about 1%, alternatively between about 0.1% and about 10%, alternatively between about 0.1% and about 5%, alternatively between about 0.1% and about 3%, alternatively between about 1% and about 3%, alternatively between about 2% and about 3%.

In one embodiment, the coating 202 includes an incompletely sintered ceramic phase. In another embodiment, the coating 202 includes an essentially completely sintered ceramic phase. In yet another embodiment, the coating 202 includes a completely sintered ceramic phase. As used herein, an incompletely sintered ceramic phase indicates up to 95% sintered, an essentially completely sintered ceramic phase indicates 95% sintered up to 99% sintered, and a completely sintered ceramic phase indicates more than 99% sintered.

The coating 202 may include any suitable hardness, including, but not limited to, a hardness between about 35 HRC to about 70 HRC, alternatively between about 35 HRC to about 60 HRC, alternatively between about 45 HRC to about 70 HRC, alternatively between about 40 HRC to about 65 HRC, alternatively between about 35 HRC to about 50 HRC, alternatively between about 45 HRC to about 60 HRC, alternatively between about 55 HRC to about 70 HRC.

The article 100 may be any suitable article, including but not limited to, a boiler component. Suitable boiler components, may include, but are not limited to, a coal-fired boiler component, a pulverized coal-fired boiler component, a steam locomotive boiler component, a boiler tube, or combinations thereof In one embodiment, wherein the article 100 is a boiler tube (shown schematically as an example in FIG. 1), the coating 202 is applied to an exterior surface 208 of the boiler tube. The exterior surface 208 may be within the boiler tube (shown) or outside the boiler tube. The substrate 200 of the article 100 may include any suitable material composition, including, but not limited to, carbon steels, low-alloy ferritic steels, stainless steels, nickel-based alloys, or combinations thereof.

In one embodiment, the method includes applying a bond coat material to the substrate 200, the bond coat material forming a bond coat 204 disposed between the substrate 200 and the coating 202. The bond coat 204 may include any suitable composition, including, but not limited to, nickel-aluminum alloy, MCrAlY (where M is a metal, which could be iron, nickel, or cobalt), and combinations thereof. The bond coat 204 may include any suitable bond coat thickness 210, including, but not limited to, a bond coat thickness 210 between about 5 μm and about 150 μm, alternatively between about 10 μm and about 100 μm, alternatively between about 10 μm and about 50 μm, alternatively between about 25 μm and about 75 μm, alternatively between about 40 μm and about 90 μm, alternatively between about 50 μm and about 100 μm, alternatively between about 70 μm and about 100 μm.

In one embodiment, the coating 202 reduces erosion, corrosion, or both of the article 100 under operating conditions for a boiler component, relative to a comparable article not including the coating 202. In another embodiment, the coating 202 reduces the deposition rate of slag on the article 100, increases the rate of slag shedding from the article 100, or both, under operating conditions for a boiler component, relative to a comparable article not including the coating 202.

### EXAMPLES

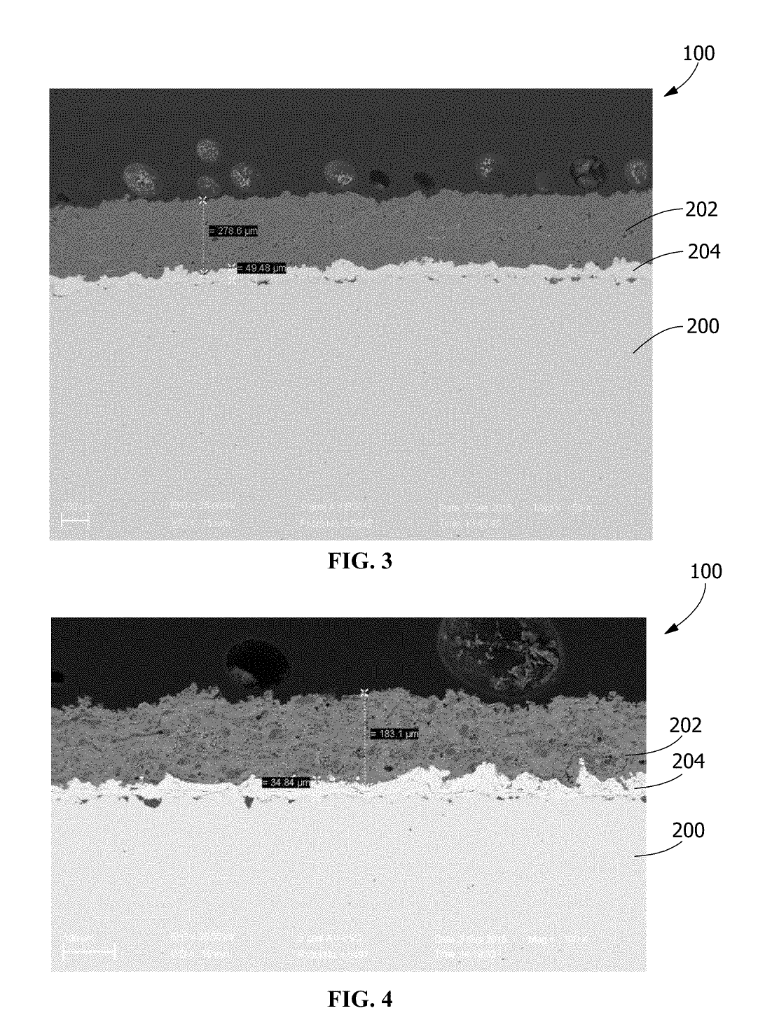

Referring to FIG. 3, in one exemplary embodiment, a method for coating an article 100 includes applying a coating precursor to a substrate 200 of the article 100. The coating precursor includes fly ash derived from combustion of Western coal, and includes a particle size distribution between about 300 nm to about 100 μm. The fly ash includes a particle morphology which is predominantly spherical. The coating precursor is applied to the substrate 200 by air plasma spray, wherein the substrate 200 includes a carbon steel. A bond coat 204 is disposed between the substrate 200 and the coating 202, the bond coat 204 including a nickel-aluminum alloy having, by weight percent, about 95% nickel and about 5% aluminum. The bond coat 204 includes a bond coat thickness 210, the bond coat 204 including a bond coat thickness 210 of about 2 mils. The coating 202 includes a coating thickness 206 of about 11 mils. The coating 202 includes a hardness between about 49 HRC to about 62 HRC.

Referring to FIG. 4, in another exemplary embodiment, a method for coating an article 100 includes applying a coating precursor to a substrate 200 of the article 100. The coating precursor includes fly ash derived from combustion of Powder River Basin coal, and includes a particle size distribution between about 200 nm to about 100 μm. The fly ash includes a particle morphology which is predominantly spherical. The coating precursor is applied to the substrate 200 by air plasma spray, wherein the substrate 200 includes a carbon steel. A bond coat 204 is disposed between the substrate 200 and the coating 202, the bond coat 204 including a nickel-aluminum alloy having, by weight percent, about 95% nickel and about 5% aluminum. The bond coat 204 includes a bond coat thickness 210, the bond coat 204 including a bond coat thickness 210 of about 1 mil. The coating 202 includes a coating thickness 206 of about 7 mils. The coating 202 includes a hardness between about 41 HRC to about 60 HRC.

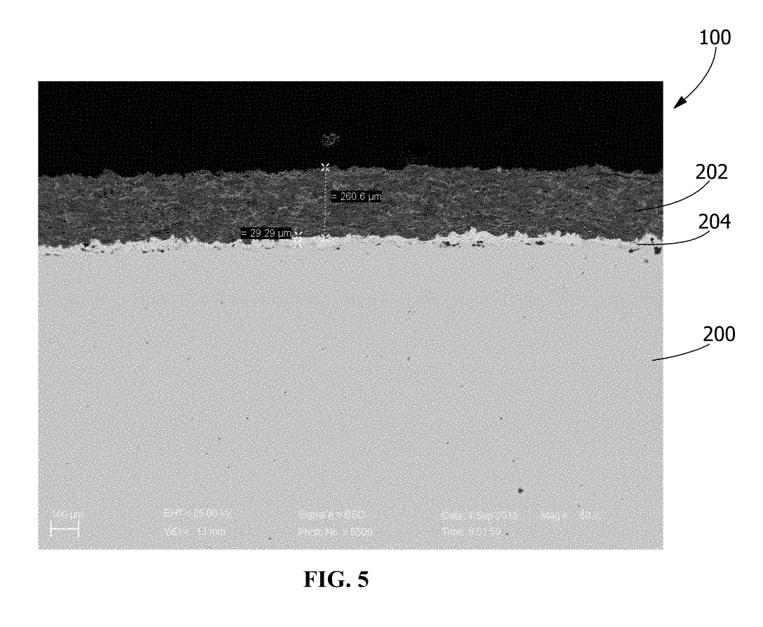

Referring to FIG. 5, in yet another exemplary embodiment, a method for coating an article 100 includes applying a coating precursor to a substrate 200 of the article 100. The coating precursor includes fly ash derived from combustion of Illinois Basin coal. The fly ash includes a particle morphology which is predominantly spherical. The coating precursor is applied to the substrate 200 by air plasma spray, wherein the substrate 200 includes a carbon steel. A bond coat 204 is disposed between the substrate 200 and the coating 202, the bond coat 204 including a nickel-aluminum alloy having, by weight percent, about 95% nickel and about 5% aluminum. The bond coat 204 includes a bond coat thickness 210, the bond coat 204 including a bond coat thickness 210 of about 1 mil. The coating 202 includes a coating thickness 206 of about 10 mils. The coating 202 includes a hardness between about 41 HRC to about 51 HRC.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for coating an article, comprising:
applying a feedstock as a coating precursor by a thermal spray process, the feedstock including fly ash, the fly ash preferentially forming a coating disposed on a substrate of the article.

2. The method of claim 1, wherein the thermal spray process is selected from the group consisting of plasma spray, high-velocity air-fuel spraying (HVAF), high-velocity air plasma spraying (HV-AP), detonation spraying, flame spraying, high velocity oxy-fuel spraying (HVOF), cold (warm) spraying, and combinations thereof.

3. The method of claim 2, wherein the thermal spray process includes air plasma spraying.

4. The method of claim 3, wherein applying the fly ash includes an energy input of between about 30 kW and about 60 kW.

5. The method of claim 1, wherein the fly ash includes about 15 wt. % to about 60 wt. % SiO₂, about 5 wt. % to about 35 wt. % Al₂O₃, about 4 wt. % to about 40 wt. % Fe₂O₃, and about 1 wt. % to about 40 wt. % CaO.

6. The method of claim 5, wherein the coating precursor further includes up to about 35 wt. % additional material selected from the group consisting of MgO, SO₃, Na₂O, K₂O, TiO₂, unburnt carbon, and combinations thereof

7. The method of claim 1, wherein the fly ash includes a particle size distribution between about 200 nm to about 200 μm.

8. The method of claim 1, wherein the fly ash is derived from coal combustion.

9. The method of claim 1, wherein the coating precursor further includes a balancing composition.

10. The method of claim 9, wherein the balancing composition is selected from the group consisting of SiO₂, Al₂O₃, Fe₂O₃, CaO, MgO, SO₃, Na₂O, K₂O, TiO₂, unburnt carbon, and combinations thereof.

11. The method of claim 1, further comprising applying a bond coat material to the substrate, the bond coat material forming a bond coat disposed between the substrate and the coating.

12. The method of claim 11, wherein the bond coat includes a material selected from the group consisting of nickel-aluminum alloy, MCrAlY, and combinations thereof, wherein M is one of iron, nickel, and cobalt.

13. The method of claim 12, wherein the substrate includes a material selected from the group consisting of carbon steels, low-alloy ferritic steels, stainless steels, nickel-based alloys, and combinations thereof

14. The method of claim 11, wherein the bond coat includes a bond coat thickness of between about 10 μm and about 100 μm.

15. The method of claim 1, wherein the coating includes a coating thickness of between about 25 μm and about 1,000 μm.

16. The method of claim 1, wherein the article is a boiler component.

17. The method of claim 4, wherein the boiler component is a boiler tube, and the coating is applied to an exterior surface of the boiler tube.

18. The method of claim 1, wherein the coating is essentially free of hexavalent chromium.

19. The method of claim 18, wherein the coating is free of hexavalent chromium.

20. The method of claim 1, wherein the coating includes a porosity of less than about 5%.

21. The method of claim 1, wherein the coating includes an essentially completely sintered ceramic phase.

22. The method of claim 1, wherein the coating includes a hardness between about 35 HRC to about 70 HRC.

23. A feedstock for a thermal spray process, the feedstock comprising:
a fly ash derived from coal combustion.

24. The feedstock of claim 23, wherein the fly ash includes about 15 wt. % to about 60 wt. % SiO₂, about 5 wt. % to about 35 wt. % Al₂O₃, about 4 wt. % to about 40 wt. % Fe₂O₃, and about 1 wt. % to about 40 wt. % CaO.

25. The method of claim 23, wherein the feedstock further includes up to about 35 wt. % additional material selected from the group consisting of MgO, SO₃, Na₂O, K₂O, unburnt carbon, and combinations thereof.

26. The method of claim 23, wherein the fly ash includes a particle size distribution between about 200 nm to about 200 μm.
